(19) United States
(12) Patent Application Publication
(10) Pub. No.: US 2021/0291528 A1
(43) Pub. Date: Sep. 23, 2021

(54) PRINTHEAD SERVICE STATIONS WITH SPITROLLERS

(71) Applicant: Hewlett-Packard Development Company, L.P., Spring, TX (US)

(72) Inventors: Jeffrey Thielman, Sant Cugat del Valles (ES); Santiago Forcada Pardo, Sant Cugat del Valles (ES); Xavier Bruch Pla, Sant Cugat del Valles (ES)

(73) Assignee: Hewlett-Packard Development Company, L.P., Spring, TX (US)

(21) Appl. No.: 17/258,479

(22) PCT Filed: Dec. 14, 2018
(86) PCT No.: PCT/US2018/065869

§ 371 Date: Jan. 7, 2021

(51) Int. Cl. B41J 2/165

(52) U.S. Cl. CPC B41J 2/16508; B41J 2/16511; B41J 2/16535

(57) ABSTRACT

A printhead service station comprises a printhead cleaner, a motor to move the printhead cleaner along a first direction during a printhead cleaning operation, and a spitroller to catch waste printing liquid during printhead cleaning. Therein, an axis of rotation of the spitroller is oriented substantially parallel to the first direction, and a rotation of the spitroller is driven by the motor.

### BACKGROUND

In some inkjet printers, replaceable maintenance cartridges (printhead cleaners, PHC) are provided. Therein, spitrollers may be used to catch aerosols during cleaning and servicing of print nozzles by ejecting waste printing liquid from the print nozzles onto the spitrollers.

### BRIEF DESCRIPTION OF DRAWINGS

Examples will now be described, by way of non-limiting example, with reference to the accompanying drawings, in which:

FIG. 1 is a simplified schematic of an example of a printhead service station;

FIG. 2 is a simplified schematic of an example of a printer;

FIG. 3 shows an example of a printhead cleaning device that may be used in conjunction with the printhead service station of FIG. 3;

FIG. 4 shows a printhead service station according to an example, wherein a removable printhead cleaning device has been removed;

FIG. 5 shows a schematic drawing of a spitroller with a scraper; and

FIG. 6 shows a detail of a transmission member of the printhead service station according to an example.

### DETAILED DESCRIPTION

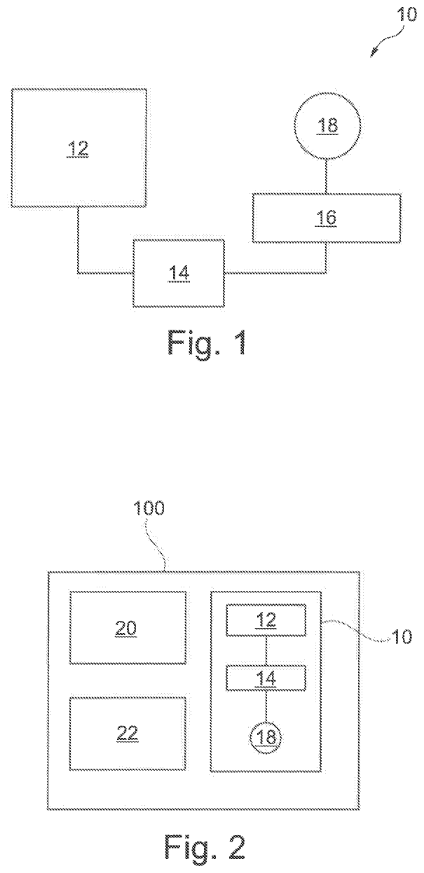

FIG. 1 shows a printhead service station 10 according to an example, wherein a printhead cleaner 12 is provided for performing cleaning and maintenance operations on a printhead of an inkjet printer. The cleaning and maintenance operations may comprise removing waste printing liquid that is spit from printer nozzles, wiping or capping printer nozzles. The printhead cleaner 12 may be removably connected to a motor 14 for driving a motion of the printhead cleaner 12 in a first direction relative to the printer nozzles and relative to a housing (not shown in FIG. 1) of the printhead service station 10. A transmission 16 is provided in order to removably connect a spitroller 18 to the motor 14, in order to drive a rotation of the spitroller 18. Therein, an axis of rotation of the spitroller 18 is oriented substantially parallel to the first direction. According to some examples, more than one spitroller 18 may be provided.

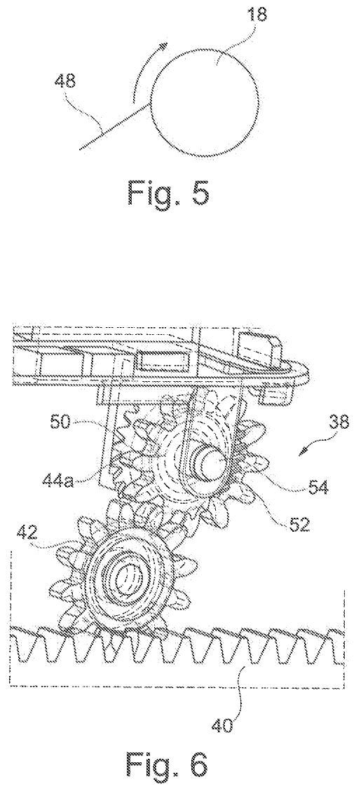

The spitroller 18 is provided as a means of controlling aerosol generated by the printhead while servicing. The larger the space between the printhead and the printhead cleaner 12 during a cleaning operation, the larger amount of aerosol is generated. When using the spitroller 18, it may be placed in close proximity to the printer nozzles being cleaned so that the space between a print nozzle and the spitroller 18 of the printhead cleaner 12 can be very small and well controlled. The printing liquid fired onto the spitroller 18 may drip off the spitroller 18 into a waste tank. According to an example, a scraper (see, for example, FIG. 5) may be provided to wipe the excess printing liquid off the spitroller 18 when it is spun, thus preventing a buildup of printing liquid on the spitroller 18.

With the example structure as shown in FIG. 1, a removable cartridge can be provided which comprises the printhead cleaner 12, the spitroller 18 and the transmission 16 and which does not need a separate motor for driving the rotation of the spitroller 18. When the removable cartridge is inserted into the printhead service station 10, the printhead cleaner 12 engages with the motor 14 of the printhead service station 10, and the transmission 16 for driving the spitroller 18 engages with a suitable engaging member provided in the printhead service station 10.

FIG. 2 shows an example of an inkjet printer 100, wherein a printhead 20 is provided in order to deposit printing liquid droplets at predetermined positions on a medium that is transported past the printhead 20 by a media transport device 22. The inkjet printer 100 further comprises a printhead service station 10 as described above, comprising a printhead cleaner 12, a spitroller 18 and a motor 14 associated to both the printhead cleaner 12 and to the spitroller 18 as to move the printhead cleaner 12 along a first direction during a printhead cleaning operation and to cause rotation of the spitroller 18. Therein, the printhead cleaner 12 and the spitroller 18 may be provided as a user-replaceable unit and the motor 14 may be provided in a portion of the printhead service station that remains fixed within the printer 100 when the removable printhead cleaner and spitroller unit is replaced.

Thus, the user-replaceable cartridge comprising the printhead cleaner 12 and the spitroller 18 does not need to be provided with a motor for driving the rotation of the spitroller 18, which reduces the cost and complexity of manufacturing this removable part of the printer 100. The motor 14 can be provided in the printer 100 as a permanently fixed component, and the printhead cleaner 12 may removably connect to the motor 14 when the replaceable cartridge is inserted into the printer 100.

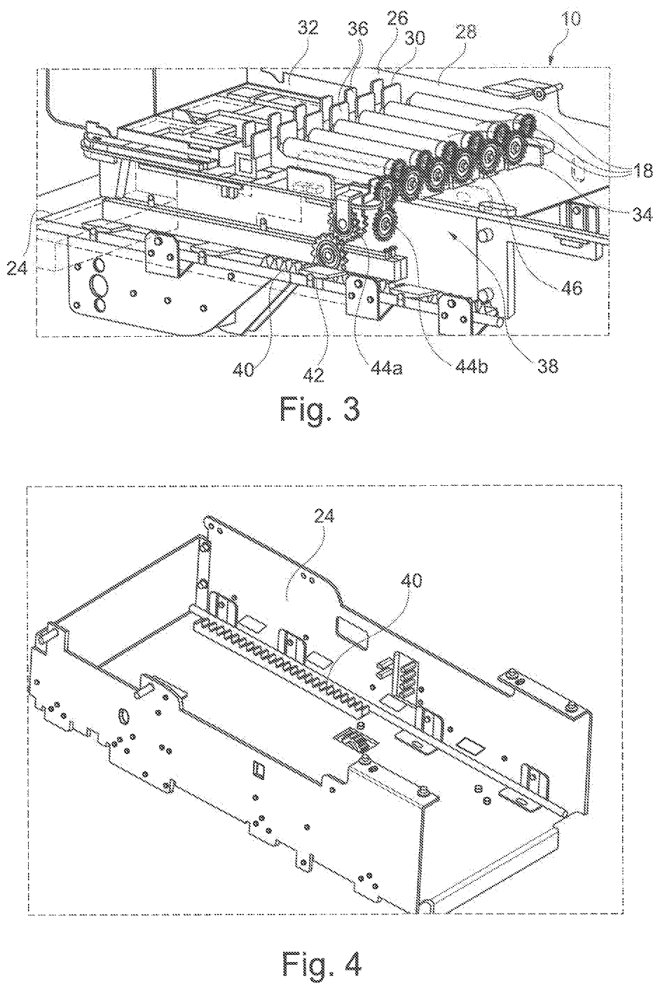

FIG. 3 shows an example of a printhead service station 10. Therein, a housing 24 of the printhead service station 10 receives a removable printhead cleaning and servicing unit 26 which unit 26 may comprise a spitting section 28, a wiping section 30 and a capping section 32. The spitting section may comprise multiple spitrollers 18 arranged parallel to each other, as well as a waste tank 34 wherein waste printing liquid that has dripped off the spitrollers 18 can be collected. The wiping section 30 may comprise multiple wiper elements 36 for wiping the print nozzles after waste printing liquid has been ejected therefrom. The capping section 32 may seal the printer nozzles in order to prevent the printing liquid drying out when the printhead is not used. Thus, as the printhead cleaning and servicing unit 26 is moved passed the printer nozzles of the printhead, waste printing liquid is ejected from the nozzles, which are then subsequently cleaned by the wiper elements 36 and capped in the capping section 32.

For driving rotation of the spitrollers 18, a transmission 38 is provided which comprises a rack 40 fixed to the housing 24 of the printhead service station 10, a first gear 42 in engagement with the rack 40, a pair of bevel gears 44a, 44b in order to change the movement direction within the transmission 38 and a set of second gears 46 which connect the spitrollers 18 to the bevel gear 44b. According to further examples, another mechanism for changing the direction of rotation by 90° could be used instead of the bevel gears, such as a worm and wormwheel or any other suitable means for transmitting rotatory motion between two shafts oriented perpendicular to each other.

As the printhead cleaning and servicing unit 26 is moved in a direction parallel to the rack 40 in order to perform the spitting, wiping and capping processes by a motor provided in the printhead service station 10, the first gear 42 is rotated due to the relative motion between the movable printhead cleaning and servicing unit 26 and the housing 24 of the stationary printhead service station 10, thus driving, via the bevel gears 44a, 44b and the second gears 46, all of the the spitrollers 18 to rotate simultaneously around their axes, which axes are oriented substantially parallel to the direction of motion of the printhead cleaning and servicing unit 26.

The use of the rack 40 allows the linear motion of the printhead cleaning and servicing unit 26 to be converted into rotational motion of the first gear 42, and further enables the first gear 42 to be easily connected and disconnected to the rack 40 when the printhead cleaning and servicing unit 26 is removed or replaced. Similarly, the mechanism for driving the linear motion of the printhead cleaning and servicing unit 26 along the first direction which is parallel to the lengthwise direction of the rack 40 may be easily and automatically detachable from the motor 14 in the printhead service station 10.

The bevel gears 44a, 44b provide a low-cost and reliable solution to the task of driving the spitrollers 18 when the direction of movement on the spitrollers 18 is substantially orthogonal to the movement of the printhead cleaning and servicing unit 26, while both the spitrollers 18 and the printhead cleaning and servicing unit 26 are driven by the same motor 14.

As illustrated in FIG. 4, the rack 40 may be arranged substantially parallel to a wall of the housing 24 of the printhead service station 10 and may be positioned and dimensioned such that it covers a suitable portion of the total distance that the printhead cleaning and servicing unit 26 is moved relative to the housing 24 during the spitting, wiping and capping operations. Thus, it can be ensured that the spitrollers 18 rotate during a spitting operation. According to examples, the rack 40 may be dimensioned such that the spitrollers 18 do not rotate during the subsequent wiping and capping operations.

As shown in FIG. 5, the spitroller 18 may further be provided with a scraper 48 to scrape the waste printing liquid off the surface of the spitroller 18 and to prevent buildup of waste printing liquid on the spitroller 18. As indicated in FIG. 5, the scraper 48 on the spitroller 18 is most effective in the rotational direction of movement indicated by an arrow, whereas the scraper 48 may be less effective of the spitroller 18 were rotated in the opposite direction.

Additionally, according to an example, the spitroller 18 may be spun continuously while spitting or priming a large volume of printing liquid onto it. Keeping a constant rotational direction for these cases would ensure efficient transport of waste printing liquid from the spitroller 18 into the waste tank 34.

FIG. 6 shows a detail of the transmission 38 according to an example, wherein a clutch mechanism 50 is inserted between a third gear 52 and the first bevel gear 44a, wherein the third gear 52 is in engagement with the first gear 42. Thus, the direction in which power is applied to the spitrollers 18 can be controlled. The shaft 54 may be permanently attached to the third gear 52, and the clutch mechanism 50 may be permanently attached to the first bevel gear 44a. An example for a clutch mechanism 50 is a clutch which grips the shaft 52 when turning in one direction, thus causing the first bevel gear 44a to rotate together with the third gear 52. When the third gear 52 rotates in the other direction, the clutch releases the grip on the shaft 54 and the first bevel gear 44a does not rotate. According to further examples, the clutch could be placed at a different position within the transmission 38 for driving a rotation of the spitrollers 18.

In the example wherein a clutch mechanism 50 is provided, two types of movements can be enabled:

First, large continuous rotations of the spitrollers 18 in one direction can be performed. For example, if the overall gear ratio of the transmission 38 allows three rotations of the spitrollers 18 when the printhead cleaning and servicing unit 26 is moved by a large distance, such as e.g. 6 cm along the rack, the service station motor 14 can be instructed to move the printhead cleaning and servicing unit 26 by this distance, and the rotation of the spitrollers 18 can thus be controlled by adjusting the movement distance and speed of the printhead cleaning and servicing unit 26 along the direction parallel to the rack 40. According to further examples, higher or lower gear ratios may be used, wherein the overall gear ration of the transmission 38 may allow between one and five rotations of the spitrollers 18.

Second, there are scenarios where a large volume of printing liquid is spit over spitrollers 18 that are moving, such as in a purge of shipping fluid or priming large amounts of printing liquid to clear clogged print nozzles. When these scenarios are encountered, the printhead service station 10 may move the printhead cleaning and servicing unit 26 back and forth by small distances, such as just a few millimeters. Each movement of the printhead cleaning and servicing unit 26 will then advance the spitrollers 19 by a small amount. However, since the clutch mechanism 50 enables rotation of the spitrollers 18 in a constant direction and does not rotate the spitrollers 18 of the printhead cleaning and servicing unit 26 is moved in the opposite direction, a repeated back and forth movement of the printhead cleaning and servicing unit 26 will result in an overall rotation of the spitrollers 18 at a slow speed.

By providing the transmission 38 with or without the clutch mechanism 50, no additional motor needs to be provided for driving the rotation of the spitrollers 18. Thus, the complex planetary gear motor of prior art printhead cleaners with spitrollers is not needed in the printhead service station 10 and the printer 100 according to the examples. This reduces the manufacturing cost and complexity of the printhead service station 10. Since no additional motor needs to be powered and controlled, the printhead service station 10 according to the examples also has reduced associated operating and development costs.

Since the transmission 38 can be formed from plastic gears of appropriate sizes and mechanical properties, the manufacturing cost for the transmission 30 can be kept low.

According to the examples, the motion of the spitrollers 18 can be controlled by selecting the length of the rack 40 and the placement of the rack 40 along the service station axis. Thus, it can be selected during which portions of the total travel distance of the printhead cleaning and servicing unit 26 the spitrollers 18 are rotated. Additionally, this system gives control of when the gears spin and for how many rotations. The length of the rack 40 and the gear ratio of the transmission 38 may be designed such that the spitrollers 18 may be spun for a predetermined number of rotations when the printhead cleaning and servicing unit 26 is moved along the printer nozzles.

If the position of the rack 40 is changed, the location of the rotation of the spitrollers 18 within the range of movement of the printhead cleaning and servicing unit 26 is adjusted. If the spitrollers 18 are not to spin while the capping process of the printhead cleaning and servicing unit 26 is occurring, the rack 40 may be is placed so that the end of the rack is positioned just before the capping process of the printhead cleaning and servicing unit 26 begins. Since the spitrollers 18 and the transmission 38 have low friction, the first gear 42 of the transmission 38 automatically meshes with the rack 40 when the printhead cleaning and servicing unit 26 is moved to a position where the spitrollers 18 are to be rotated.

When a clutch mechanism 50 is used, the service station motor 14 may be used to perform small movements to continuously move the spitrollers 18 while doing large spits or primes, by moving the printhead cleaning and servicing unit 26 backward and forward by a small distance for an extended period of time.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Printhead service station, comprising:
a printhead cleaner;
a motor to move the printhead cleaner along a first direction during a printhead cleaning operation;
a spitroller to catch waste printing liquid during printhead cleaning, wherein an axis of rotation of the spitroller is oriented substantially parallel to the first direction, and wherein rotation of the spitroller is driven by the motor.

2. Printhead service station according to claim 1, wherein the printhead cleaner and the spitroller are removably provided in the printhead service station.

3. Printhead service station according to claim 1, further comprising a clutch member in order to ensure that the spitroller rotates in a single direction as the printhead cleaner is moved forwards and backwards along the first direction.

4. Printhead service station according to claim 1, wherein a scraper is provided to scrape printing liquid off the spitroller as the spitroller rotates.

5. Printhead service station according to claim 1, further comprising an engaging member provided on the printhead service station to removably engage with a transmission to drive rotation of the spitroller.

6. Printhead service station according to claim 5, wherein the engaging member comprises a toothed rack to engage with a gear of the transmission.

7. Printhead service station according to claim 6, wherein the toothed rack is positioned in a service station housing such that motion of the spitroller is actuated along a portion of the motion of the printhead cleaner.

8. Printhead service station according to claim 1, further comprising a printhead capping module and a printhead wiping module.

9. Printhead service station according to claim 1, further comprising multiple spitrollers.

10. Printhead cleaning device, comprising:
a printhead cleaning module to clean printhead nozzles;
a spitroller to catch waste printing liquid during printhead cleaning;
a transmission to drive rotation of the spitroller, wherein the transmission comprises a transmission member to transfer a rotation to move the print head cleaner to the spitroller.

11. Printhead cleaning device according to claim 10, further comprising a clutch to ensure that the direction of rotation of the spitroller remains constant.

12. Printhead cleaning device according to claim 11, wherein a scraper is provided to scrape printing liquid off the spitroller as the spitroller rotates.

13. Printhead cleaning device according to claim 10, further comprising a printhead capping module and a printhead wiping module.

14. Printhead cleaning device according to claim 10, further comprising a plurality of spitrollers.

15. Inkjet printer, comprising:
a printhead;
a printhead service station, comprising:
a printhead cleaner;
a spitroller;
a motor associated to the printhead cleaner and to the spitroller as to move the printhead cleaner along a first direction during a printhead cleaning operation and to cause rotation of the spitroller; and
a media transport device for transporting medium through the printer.
